(19) United States
(12) Patent Application Publication
(10) Pub. No.: US 2018/0273876 A1
(43) Pub. Date: Sep. 27, 2018

(54) HEAT RECOVERY FOR SEED CONDITIONER AND COOKER OPERATION

(71) Applicant: Crown Iron Works Company, Roseville, MN (US)

(72) Inventors: Corey Alan Paulson, New Brighton, MN (US); Benjamin Wayne Floan, Andover, MN (US)

(21) Appl. No.: 15/764,911

(22) PCT Filed: Sep. 30, 2016
(86) PCT No.: PCT/US2016/054988

§ 371 Date: Mar. 30, 2018

Related U.S. Application Data
(60) Provisional application No. 62/236,553, filed on Oct. 2, 2015.

(51) Int. Cl. C11B 1/04; A23D 9/02

(52) U.S. Cl. CPC C11B 1/04; A23D 9/02

(57) ABSTRACT

To extract oil from oil seeds in a mechanical pressing operation, the oil seeds may be conditioned and then cooked before being subsequently pressed to release the oil contained in the seeds. In one application, a conditioning vessel is used that includes a shell through which the oil seeds move during operation and multiple heat transfer stages. Downstream of the conditioning vessel, a cooking vessel receives the oil seeds pre-conditioned in the conditioning vessel and cooks the oil seeds, generating a gas-containing stream that includes water vapor. The gas-containing stream is recycled back to one or more of the heat transfer stages of the conditioning vessel, providing direct heat transfer from the cooking vessel to the conditioning vessel. This arrangement can increase the energy efficiency of the operation and improve the performance of the system.

This application claims the benefit of U.S. Provisional Patent Application No. 62/236,553, filed Oct. 2, 2015, the entire contents of which are incorporated herein by reference.

### TECHNICAL FIELD

This disclosure relates to systems for conditioning and cooking granular matter and, more particularly, to heat recovery arrangements for efficiently operating such systems.

### BACKGROUND

Oil seeds and beans provide a natural and renewable source of oil for a variety of end use applications. To extract oil from oleaginous matter, the oleaginous matter is first harvested and transported to an oil extraction facility. Upon arriving at the oil extraction facility, the oleaginous matter may either be placed in storage or, depending on the setup of the facility, sent to a dryer to remove excess moisture. Typically, the oleaginous matter is then cleaned to remove foreign matter that will negatively affect downstream crushing and, if containing a hull, dehulled to expose and release the oil-bearing portion of the oleaginous matter.

Once suitably processed, the oleaginous matter is preheated and flaked. Preheating helps ensure that the oleaginous matter will not shatter during subsequent flaking, while the flaking process itself increases the surface area of the oleaginous matter for processing. After flaking, the flaked material is usually cooked to reduce the viscosity of the oil in the oleaginous matter and to make the oil easier to separate from the remaining portion of the matter. Subsequently, the cooked oleaginous matter is pressed to extract the oil from the matter. During mechanical pressing, the cooked oleaginous matter is squeezed under pressure to separate liquid oil from a resulting cake. Modern press machines generally remove fifty to sixty percent of the oil in the cooked oleaginous matter. Depending on the application, the resulting cake is sent to a solvent extractor where residual oil is removed from the cake using solvent extraction.

In practice, the processing steps performed on the oleaginous matter to recover oil both consume and liberate thermal energy. For example, during preheating in which oleaginous matter is prepared for subsequent flaking, thermal energy is input to a preheating conditioning vessel to raise the temperature of the oleaginous matter. Similarly, during cooking, thermal energy is input to a cooking vessel to further heat and cook flaked oleaginous matter. While the cooking process consumes thermal energy, it also releases thermal energy in the form of a vapor stream containing vaporized water. This vapor stream is lost thermal energy when discharged to atmosphere.

### SUMMARY

In general, this disclosure relates to systems and techniques for recovering thermal energy liberated during the processing of granular material, such as oleaginous seeds and beans, and directly reusing that thermal energy in upstream processes to improve the overall thermal efficiency of the processing operation. In some examples, the thermal energy recovery systems and techniques are implemented in a process for preparing oleaginous matter for downstream pressing and optional solvent extraction. To prepare the oleaginous matter for downstream processing, the matter may first be conditioned in a conditioning vessel in which the matter is heated. Heating the matter in the conditioning vessel can make the matter pliable for subsequent rolling or flaking, helping to ensure the matter does not shatter during size reduction. Subsequently, the conditioned matter can be processed in a size reduction device, such as a rolling or flaking mill, to increase the surface area of the matter for later pressing and solvent extraction. The resulting particulate fragments can then be cooked in a higher temperature cooking vessel, causing the fragments to release an off gas containing water vapor and also reducing the viscosity of the oil contained in the fragments. The resulting cooked fragments can be mechanically pressed between plates or rollers to squeeze oil out of the fragments and then processed in a solvent extractor to further increase the amount of oil recovered from the fragments.

In some examples according to the disclosure, the thermal energy liberated from the fragments during the cooking process in form of off gas containing water vapor is recovered and reused in the upstream conditioning vessel. For example, the off gas generated and released from the cooking vessel may be recycled directly back to the conditioning vessel and passed through a portion of the conditioning vessel to transfer the thermal energy from the off gas to fresh oleaginous matter being processed in the conditioning vessel. That is, the off gas may be recycled from an outlet of the cooker to an inlet of the conditioning vessel without passing the gas through an intermediate heat exchanger where thermal energy is transferred from the gas to an intermediate heat transfer fluid which, in turn, is passed through the conditioning vessel.

Direct use of off gas from the cooking vessel in the conditioning vessel can increase the thermal efficiency of the heat transfer process by reducing heat loss that occurs when thermal energy is first transferred from the off gas to a different thermal transfer fluid in an intermediate heat exchanger. Moreover, direct use of off gas from the cooking vessel can reduce the complexity and cost of the processing equipment by eliminating pumps, pipes, valves and instrumentation otherwise needed to operate an intermediate heat exchanger in order to recover and pass energy downstream.

To accommodate direct use of off gas from the cooking vessel in the conditioning vessel, the off gas, in some configurations, is passed through a filtration device before being introduced into the conditioning vessel. The filtration device can help remove particulate matter entrained within the off gas from the cooking vessel which, if not removed, may form accumulated fouling within the conditioning vessel. Further, to monitor operation of conditioning vessel and/or detect accumulated fouling from the off gas, the conditioning vessel may be fitted with temperature monitors and/or pressure monitors. The temperature monitors and/or pressure monitors can be used to measure a temperature drop or pressure drop, respectively, across the portion of the conditioning vessel through which the off gas travels. This can provide the operator with information regarding the amount of thermal energy transferred from the off gas into the conditioning vessel and/or provide an indication of fouling within the vessel. Additionally, in some examples, the conditioning vessel is further configured with an access port which, when opened, provides access to the portion of the conditioning vessel through which the off gas travels during operation. The access port can be used to clean the conditioning vessel (e.g., with brushes, pressurized fluid) to remove accumulated fouling and ensure efficient continued operation.

In one example, a method is described that includes conveying a granular solid through a conditioning vessel having a shell and a plurality of tubes disposed within the shell. Conveying the granular solid through the conditioning vessel involves conveying the granular solid through the shell so as to contact external wall surfaces of the plurality of tubes, thereby heating the granular solid and producing a conditioned granular solid. The method further involves discharging the conditioned granular solid from the conditioning vessel and introducing the conditioned granular solid into a size reduction device. The method includes processing the conditioned granular solid within the size reduction device to reduce a size of the conditioned granular solid, thereby producing a conditioned granular solid of reduced size, and discharging the conditioned granular solid of reduced size from the size reduction device and introducing the conditioned granular solid of reduced size into a cooking vessel. In addition, the method involves heating the conditioned granular solid of reduced size in the cooking vessel to a temperature greater than a temperature to which the granular solid was heated in the conditioning vessel, thereby generating a cooked solid and a gaseous stream comprising water vapor generated from the conditioned granular solid of reduced size. The example method also includes discharging the gaseous stream from the cooking vessel and introducing the gaseous stream into at least some of the plurality of tubes of the conditioning vessel, thereby transferring thermal energy carried by the gaseous stream flowing through the plurality of tubes through wall surfaces of the tubes and into the granular solid being conveyed through the shell.

In another example, a system is described that includes a conditioning vessel, a size reduction device, a cooking vessel, and a fluid conduit. The conditioning vessel has a chamber with an inlet opening configured to receive granular solid and a discharge opening configured to discharge conditioned granular solid. The chamber is configured to receive at least one heat transfer fluid and pass the heat transfer fluid through at least a portion of the chamber, thereby heating granular solid within the chamber and producing the conditioned granular solid. The size reduction device is configured to receive the conditioned granular solid discharged from the discharge opening of the conditioning vessel and reduce a size of the conditioned granular solid so as to produce a conditioned granular size of reduced size. The cooking vessel is configured to receive the granular solid of reduced size from the size reduction device and heat the granular solid of reduced size to a temperature greater than a temperature to which the granular solid was heated in the conditioning vessel, thereby generating a cooked solid and a gaseous stream comprising water vapor generated from the conditioned granular solid of reduced size. The fluid conduit is configured to transfer the gaseous stream from the cooking vessel to the conditioning vessel, thereby providing the gaseous stream as the heat transfer fluid passing through at least a portion of the chamber.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram of an example system that includes a heat recovery arrangement according to the disclosure.

FIG. 2 is an illustration of an example configuration of a conditioning vessel that can be used in the example system of FIG. 1.

FIG. 3 is a top view illustration of an example heat transfer stage that can be used in the example conditioning vessel of FIG. 2.

FIG. 4 is a block diagram of another example system that includes a heat recovery arrangement according to the disclosure.

### DETAILED DESCRIPTION

This disclosure generally relates to systems and techniques for recovering and recycling thermal energy during the processing of granular matter, such as oleaginous seeds and beans. The granular matter can be heated and dried in a preconditioning vessel as it moves through the vessel. The preconditioning vessel may be configured as a shell and tube structure having tubes of smaller cross-sectional area (e.g., diameter) passing through the interior of the shell. In operation, the granular matter can flow on the shell side of the preconditioning vessel while a thermal transfer fluid passes through the tube side of the vessel, thereby heating the granular matter.

After passing through the preconditioning vessel, the granular matter may be optionally processed to reduce the particle size of the matter and then fed into a cooking vessel. Within the cooking vessel, the granular matter can be heated to a temperature greater than the temperature to which the matter was heated in the preconditioning vessel, thereby cooking the granular matter. Cooking can help break down the physical structure of the granular matter and prepare the granular matter for subsequent processing. For example, the granular matter may be heated to a temperature effective to vaporize water present in the matter (e.g., greater than 100 degrees Celsius at atmospheric pressure), producing a gaseous stream that contains water vapor generated from the granular matter within the cooking vessel. The gaseous stream may contain other components, such as air, entrained solids (e.g., portions of the granular matter), condensate (e.g., condensed water vapor, oil), and the like. In either case, the gaseous stream can be separated from the cooked granular matter, for example, by discharging the gaseous stream through a separate outlet port of the cooking vessel from an outlet port through which the cooked granular matter is discharged.

As described in greater detail below, the thermal energy from the gaseous stream generated in the cooking vessel can be recovered by conveying the gaseous stream to the preconditioning vessel through which the granular matter was originally processed. The gaseous stream can be conveyed through the tube side of the preconditioning vessel (in addition to or in lieu of a different thermal transfer fluid, such as steam) while the granular matter flows along the shell side of the vessel. Accordingly, as the granular matter flows along an interior of the shell side of the vessel and in contact with the exterior wall surfaces of the tubes, the gaseous stream from the cooking vessel can flow through the interior of the tubes and in contact with the interior wall surfaces of the tubes. As a result, the granular matter can be heated as thermal energy transfers via conduction to the interior of the tubes to the exterior of the tubes and into the granular matter in contact therewith.

While the disclosed systems and techniques can be used to process any desired solid feed material, in some examples, the systems and techniques are used to process oil-bearing solid feed material (which may be referred to oleaginous material). Example renewable oil-bearing solid feed materials include, but are not limited to, soybeans, rapeseed, sunflower seed, peanuts, cottonseed, palm kernels, and corn germ. Example non-renewable oil-bearing solid feed materials include asphalt from shingles and other petroleum-based waste materials. In these later applications, the petroleum-based material is typically ground into small particles before or during processing.

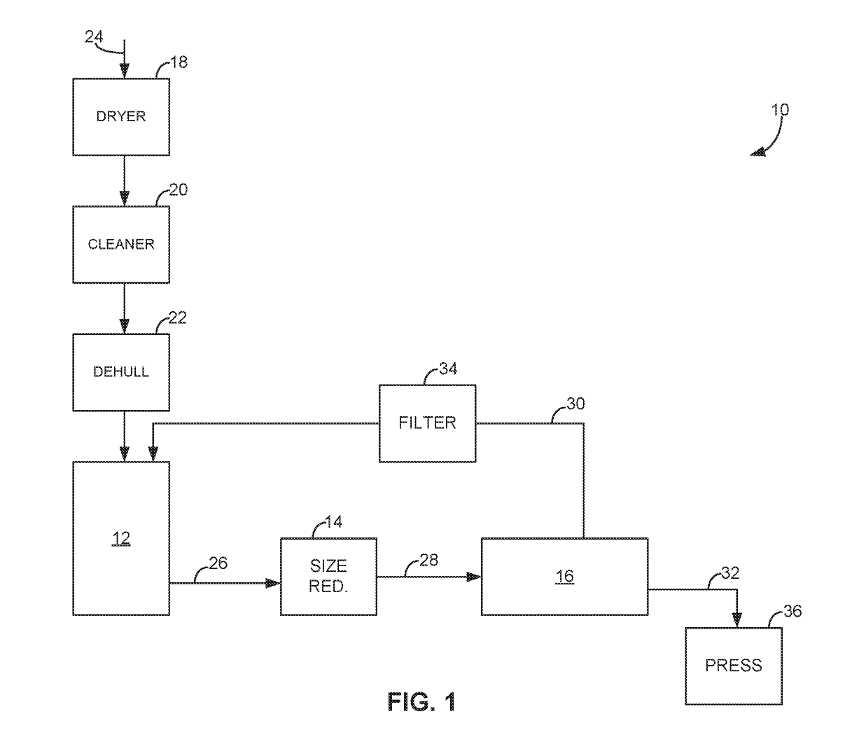

FIG. 1 is a block diagram of an example system 10 that may include a heat recovery arrangement according to the disclosure. System 10 includes a conditioning vessel 12, a size reduction device 14, and a cooking vessel 16. System 10 also includes preprocessing equipment in the form of a dryer 18, a cleaner 20, and a dehuller 22. In operation, an incoming solid feed material 24 is processed in dryer 18 to remove bulk moisture. Dryer 18 may be utilized when solid feed material 24 is delivered directly from harvesting and is wet, for example, containing greater than 10 weight percent moisture. Dryer 18 can reduce the moisture content of solid feed material 24, for example below 10 weight percent, for storage and/or subsequent processing. In either case, solid feed material 24 can be cleaned within cleaner 20 to remove foreign matter and then dehulled within dehuller 22 (in instances in which solid feed material 24 is a seed having a hull). Once suitably prepared in the preprocessing equipment, solid feed material 24 is introduced into conditioning vessel 12 for continued processing. It should be appreciated that while FIG. 1 illustrates one example system containing a conditioning vessel and cooking vessel, other systems can be used without departing from the scope of the application.

Conditioning vessel 12 is configured to heat solid feed material 24. Heating solid feed material 24 within conditioning vessel 12 can help prepare the material for subsequent oil extraction. For example, heating solid feed material 24 within conditioning vessel 12 can help prevent the material from shattering during subsequent size reduction in size reduction device 14. Solid feed material 24 may be heated within conditioning vessel 12 to a temperature effective to make the cellular wall structure of the material (in instances in which the material contains a cellular wall) pliable enough to be subsequently size reduced without shattering.

In some examples, conditioning vessel 12 is configured to heat a solid feed material 24 to a temperature ranging from 25 degrees Celsius to 80 degrees Celsius, such as a temperature ranging from 40 degrees Celsius to 70 degrees Celsius. While the temperature of incoming feed material 24 may vary, e.g., based on storage and ambient temperature conditions, in some examples, incoming feed material 24 is at a temperature less than 40 degrees Celsius, such as less than 20 degrees Celsius, less than 10 degrees Celsius, or even less than 0 degrees Celsius (e.g., less than −10 degrees Celsius). In general, the heat transfer efficiency of conditioning vessel 12 may increase as the temperature difference between incoming feed material 24 and the gaseous stream produced from cooking vessel 16 increases. In some applications, the temperature difference between incoming feed material 24 and the gaseous stream produced from cooking vessel 16 (e.g., as measured at an inlet of conditioner vessel 12) is greater than 70 degrees Celsius, such as a temperature difference ranging from 80 degrees Celsius to 130 degrees Celsius.

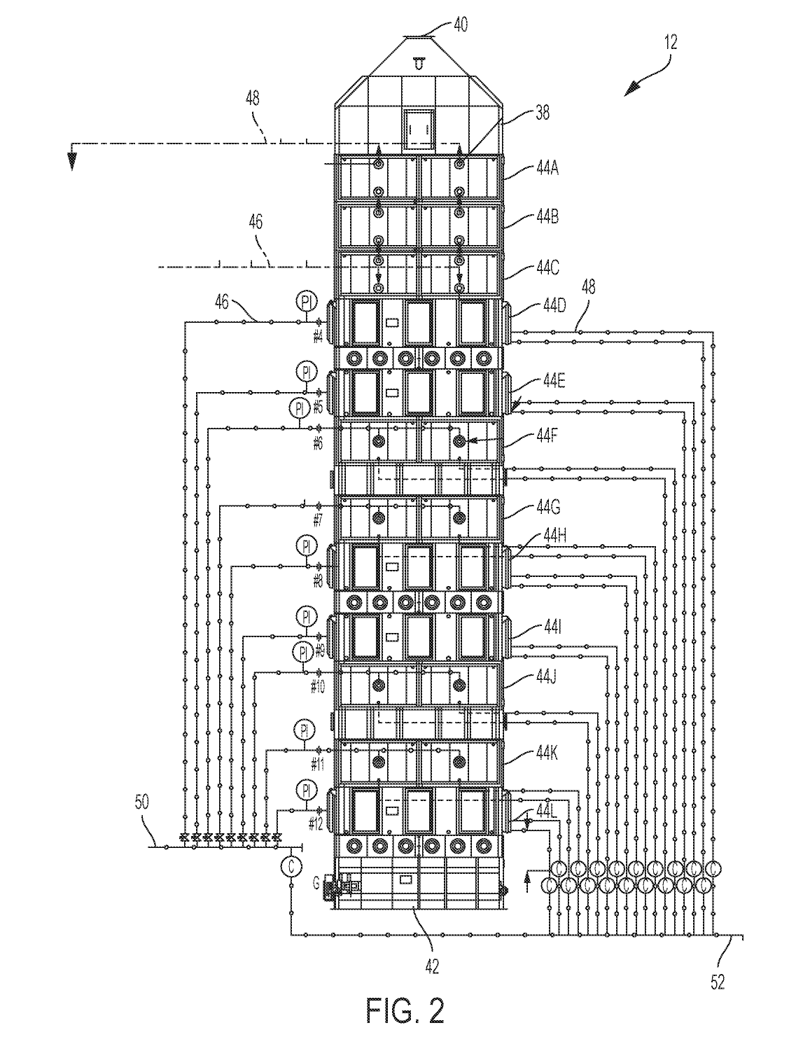

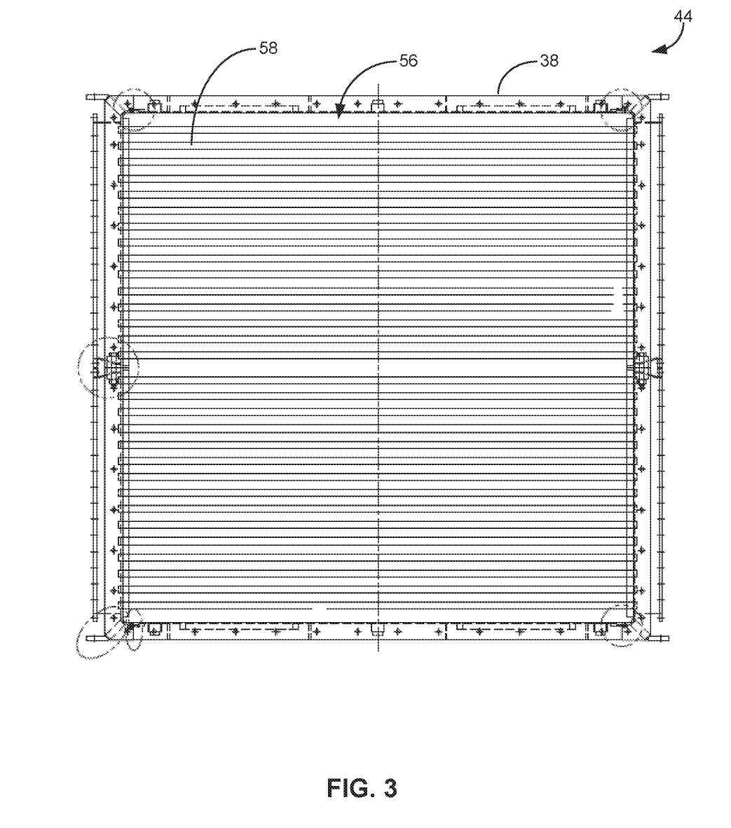

Conditioning vessel 12 can be configured to indirectly heat solid feed material 24 by passing the solid feed material though a conveyance chamber divided from one or more separate chambers though which heat transfer fluid passes. For example, as discussed in greater detail below (FIGS. 2 and 3), conditioning vessel 12 may be configured as a shell and tube structure having a main shell through which solid feed material 24 flows during operation and a plurality of tubes positioned in and/or extending through the shell through which one or more fluids having a temperature greater than the temperature of solid feed material 24 are conveyed. Conditioning vessel 12 may have an inlet opening through which solid feed material 24 is introduced into the vessel, a discharge opening through which conditioned solid feed material is discharged, and corresponding inlet opening(s) and discharge exit(s) through which thermal transfer fluid flows during operation. One commercially available piece of equipment that can be used to implement conditioning vessel 12 is the Vertical Seed Conditioner commercially available from Crown Iron Works of Minneapolis, Minn.

Solid feed material 24 can be heated within conditioning vessel 12 to produce a conditioned solid material 26 (e.g., conditioned granular solid) that is discharged from the conditioning vessel. The conditioned solid material 26 can be fed to size reduction device 14. Size reduction device 14 can be configured to reduce the size of conditioned solid material 26, increasing the surface area of the solid material for subsequent processing. In the process of reducing the size of conditioned solid material 26, size reduction device 14 can rupture cell walls of the material. This can improve the subsequent release of oil from the solid material. In different examples, the size reduction device can be implemented using a rolling mill or flaking mill. When a flaking mill is used, two opposed rollers are typically used that have smooth surfaces and are set at an appropriate gap to control the thickness of the resulting flakes. During running, one roller can revolve at a higher rpm than the other roller such that opposing roller surfaces wipe against each other. When conditioned solid material 26 is passed between the rollers, the material is pressed between the rollers producing flakes of reduced size (e.g., thickness) compared to the incoming conditioned solid material. In some examples, size reduction device 14 is configured to produce flakes having a thickness less than 1 millimeter, such as less than 0.7 mm, or less than 0.5 mm.

In the system of FIG. 1, a conditioned solid material of reduced size 28 is discharged from size reduction device 14 and introduced into cooking vessel 16. Cooking vessel 16 is configured to heat the solid material to a temperature greater than that which the material was heated in conditioning vessel 12. Cooking the conditioned solid material of reduced size 28 can provide a number of benefits. For example, cooking the solid material within cooking vessel 16 can reduce the viscosity of the oil contained within the matter, making the oil easier to extract during subsequent processing. In addition, cooking the solid material within cooking vessel 16 can deactivate enzymes (e.g., lipases) which can otherwise degrade triacylglycerides and phospholipids in the resulting extracted oil. Degradation of triacylglycerides and phospholipids may increase the amount of free fatty acid in the oil, resulting in reduced shelf life.

Cooking vessel 16 can heat the conditioned solid material of reduced size 28 to any suitable temperature to any desired amount of time. In some examples, cooking vessel 16 is configured to heat the conditioned solid material of reduced size 28 to a temperature greater than 70 degrees Celsius. For example, cooking vessel 16 may heat the conditioned solid material of reduced size 28 to a temperature ranging from 70 degrees Celsius to 95 degrees Celsius. In other examples, cooking vessel 16 is configured to heat the conditioned solid material of reduced size 28 to a temperature greater than the boiling point of water (e.g., greater than 100 degrees Celsius at atmospheric pressure). Depending on the configuration of cooking vessel 16, the vessel may operate at ambient (e.g., atmospheric) pressure, positive pressure, or negative pressure. As examples, cooking vessel 16 may be implemented using a rotary cooker, vertical stacked cooker, or other cooking vessel.

During operation, the conditioned solid material of reduced size 28 is heated within cooking vessel 16. The heat supplied to the conditioned solid material of reduced size 28 can cause water on and/or in the solid material to vaporize, producing a gaseous stream 30 that is separated from a cooked solid stream 32 discharged from cooking vessel 16. Gaseous stream 30 may be composed of water vaporized from the conditioned solid material of reduced size 28 introduced into the cooking vessel. In some examples, gaseous stream 30 includes other components such as entrained solids (e.g., particles of the conditioned solid material of reduced size 28), liquid residues (e.g., entrained oil droplets, water vapor condensate), and/or air. For example, gaseous stream 30 may contain from 15 volume percent to 50 volume percent water vapor (e.g., 25 to 40 volume percent) and from 50 volume percent to 85 volume percent air (e.g., 60 to 75 volume percent), along with any other components. Therefore, although cooking vessel 16 is described as producing a gaseous stream 30, it should be appreciated that the stream may not be composed entirely of gas phase components but may include a gas phase along with a solid phase (e.g., entrained solids) and/or liquid phase (e.g., condensates).

In the system of FIG. 1, thermal energy is recovered from the gaseous stream 30 generated by cooking vessel 16 by recycling the gaseous stream back to conditioning vessel 12. For example, gaseous stream 30 can be conveyed through a fluid conduit connecting an outlet of cooking vessel 16 to a thermal transfer fluid inlet of conditioning vessel 12. In one example, gaseous stream 30 is conveyed through a fluid conduit connecting an outlet of cooking vessel 16 to a tube-side inlet of conditioning vessel 12. The gaseous stream 30 generated by cooking vessel 16 can pass though the tube side of conditioning vessel 12, supplying heat to incoming solid material 24 being processed on the conditioning vessel. In this manner, thermal energy that would otherwise be lost in gaseous stream 30 can be recovered in conditioning vessel 12.

To help convey gaseous stream 30 from cooking vessel 16 to conditioning vessel 12 in some applications, system 10 can include one or more fan devices. For example, system 10 may include a fan positioned downstream of conditioning vessel 12 and in fluid communication with gaseous stream 30. The fan can help draw the gaseous stream 30 generated by cooking vessel 16 to conditioning vessel 12 and through one or more stages of the conditioning vessel. Additionally or alternatively, system 10 may include a fan positioned upstream of conditioning vessel 12 (e.g., between cooking vessel 16 and conditioning vessel 12). The fan can help push the gaseous stream 30 generated by cooking vessel 16 to conditioning vessel 12 and through one or more stages of the conditioning vessel.

The amount of thermal energy supplied by gaseous stream 30 to conditioning vessel 12 can vary, e.g., depending on the size and configuration of the equipment and the operating conditions of the equipment. In some examples, gaseous stream 30 has a dry bulb temperature ranging from 75 degrees Celsius to 98 degrees Celsius and a relative humidity ranging from 30% to 100%. After passing through conditioning vessel 12, the gaseous stream will have a reduced temperature. The amount of heat transferred to solid material 24 can vary depending on the dew point of gaseous stream 30, the temperature of the solid material prior to conditioning, as well as the relative proportions of each.

Conditioning vessel 12 can be configured with multiple heat transfer stages, each of which has a heat transfer fluid inlet and outlet. For example, conditioning vessel 12 may have a chamber through which solid feed material 24 flows during operation divided from one or more separate chambers through which the heat transfer fluid passes. In different examples, conditioning vessel 12 may be arranged as a shell and tube structure or plate and frame structure, where solid feed material 24 flows on one side and gaseous stream 30 flows on an opposite side of the structure. Thermal energy from gaseous stream 30 can flow through the wall dividing solid feed material 24 from the gaseous stream, thereby heating the solid feed material.

In practice, gaseous stream 30 may contain dust and other particulates that can cause accumulated fouling to occur within conditioning vessel 12 if not otherwise treated. To help address potential fouling concerns, gaseous stream 30 may be passed through a filtering device before being conveyed into and through conditioning vessel 12. In the example of system 10 in FIG. 1, gaseous stream 30 is illustrated as passing through a filtration device 34 before being introduced into conditioning vessel 12. Filtration device 34 may be a scrubber, electrostatic precipitator, mechanical filter, or other suitable type of filtration device that functions to help remove fouling materials from gaseous stream 30. Gaseous stream 30 containing fouling particulate may pass through filtration device 34 to produce a filtered gaseous stream, which is subsequently conveyed into and/or through conditioning vessel 12.

Cooking vessel 16 in FIG. 1 also generates cooked solid stream 32 that is separated from gaseous stream 30. Cooked solid stream 32 can undergo any suitable further processing after being discharged from cooking vessel 16. For example, cooked solid stream 32 may be introduced into a press 36 that physically presses the cooked solids to release liquid (e.g., oil) retaining within the cooked solids. The liquid produced during pressing can be separated from a residual solid cake. In some applications, the residual solid cake is further processed in an extraction device where liquid extraction is performed on the solid cake to recover even residual oil retained in the solid cake.

FIG. 2 is an illustration of an example configuration of a conditioning vessel that can be used as conditioning vessel 12 in the system of FIG. 1. As shown in the illustrated example, conditioning vessel 12 includes shell 38 having an inlet opening 40 through which solid feed material 24 (FIG. 10) is introduced into the conditioning vessel and a discharge opening 42 through which conditioned solid material 26 is discharged from the vessel. Conditioning vessel 12 also includes a plurality of heat transfer stages 44A-44L positioned between inlet opening 40 and discharge opening 42. Each heat transfer stage 44 may be configured to receive a heat transfer fluid and pass the heat transfer fluid through the heat transfer stage while solid feed material 24 flows though shell 38.

In the configuration of FIG. 2, inlet opening 40 is positioned at a vertically elevated location with respect to gravity relative to discharge opening 42. Further, heat transfer stages 44A-44L are stacked one on top of another to provide a vertically stacked array of heat transfer stages. In operation, solid feed material 24 can flow under a force of gravity from inlet opening 40 to discharge opening 42. In some configurations, air (which may or may not be heated) is also passed through shell 38 to help fluidize solid feed material 24 and to increase the flow through conditioning vessel 12. In other configurations, inlet opening 40, outlet opening 42, and heat transfer stages 44A-44L may not be stacked vertically but may instead be arranged horizontally or may be at other desired relative locations.

Each heat transfer stage 44 can have one or more inlets 46 through which a heat transfer fluid is introduced into the heat transfer stage and one or more outlets 48 through which the heat transfer fluid is discharged from the heat transfer stage. In different configurations, a heat transfer fluid may be passed through only a single stage before being recycled/discarded or may be passed through multiple stages before being recycled/discarded. For example, in the configuration of FIG. 2, heat transfer stages 44D-44L are illustrated as being connected to a common heat transfer fluid header (e.g., steam header) 50. Heat transfer fluid is passed from heat transfer fluid header 50, through a single heat transfer stage of heat transfer stages 44D-44L (with each heat transfer stage receiving heat transfer fluid), and then collected in a common heat transfer fluid return header 52. By contrast, heat transfer stages 44A-44C are supplied with a shared heat transfer fluid that flows in a counter current direction to the direction solid feed material 24 flows. For example, heat transfer fluid can enter at heat transfer stage 44C, flow from heat transfer stage 44C to and through heat transfer stage 44B, and then flow to and through heat transfer stage 44A. It should be appreciated that FIG. 2 illustrates one example configuration of heat transfer stages that can be used for conditioning vessel 12, and the disclosure is not limited in this respect. For example, conditioning vessel 12 may have fewer heat transfer stages 44 (e.g., two, three, four) or more heat transfer stages than is illustrated.

Independent of the specific configuration of conditioning vessel 12, the conditioning vessel is configured to receive gaseous stream 30 from cooking vessel 16 (FIG. 1). For example, one or more heat transfer stages 44 of conditioning vessel 12 can be fluidly connected to an outlet of cooking vessel 16 through which gaseous stream 30 discharges. The gaseous stream 30, which may or may not pass through filtration device 34, can enter a heat transfer stage through its respective inlet 46, pass through the stage while solid feed material 24 flows in contact with heat transfer surfaces, and then discharge through a respective outlet of the heat transfer stage. As discussed above, when gaseous stream 30 is used as a heat transfer fluid for one or more stages, the gaseous stream may pass through a single stage or may pass through multiple stages before being discharged.

In some examples, conditioning vessel 12 is configured to receive gaseous stream 30 in at least an uppermost heat transfer stage (e.g., heat transfer stage 44A), while one or more lower heat transfer stages receive a different heat transfer fluid, such as steam. For example, gaseous stream 30 may be introduced into a respective opening 46 of heat transfer stage 44A, passed through the stage, and discharged from a corresponding outlet 48 of the stage. In other examples, gaseous stream 30 is passed through multiple upper heat transfer stages (e.g., in a countercurrent direction to the direction solid feed material 24 flows), while one or more lower heat transfer stages are heated with a different heat transfer fluid. For instance, gas stream may enter conditioning vessel 12 at heat transfer stage 44C, flow from heat transfer stage 44C to and through heat transfer stage 44B, and then flow to and through heat transfer stage 44A. A different heat transfer fluid, which may or may not be at a higher temperature than gaseous stream 30, can pass through heat transfer stages 44D-44L. In yet other configurations, gaseous stream 30 is passed through all heat transfer stages 44 of conditioning vessel 12, for example, starting at a last or lowermost heat transfer stage and flowing in a countercurrent direction to a first or uppermost heat transfer stage.

Configuring conditioning vessel 12 so that gaseous stream 30 is passed through at least a first or an uppermost heat transfer stage may be useful to achieve good thermal recovery from gaseous stream 30. Solid feed material 24 is generally coolest at inlet 40 of conditioning vessel 12 and progressively increases in temperature as it passes through the conditioning vessel to outlet 42. As a result, the temperature difference between gaseous stream 30 and solid feed material 24 may be greatest at the first or uppermost heat transfer stage in conditioning vessel 12 and small in later stages. Accordingly, the driving force transferring thermal energy from gaseous stream 30 to solid feed material 24 may be greater when the gaseous stream is utilized in one or more earlier stages of the conditioning vessel. In some applications, a different thermal transfer fluid at a higher temperature than gaseous stream 30 may be utilized in one or more later or lower stages of the conditioning vessel. For example, the different thermal transfer fluid may have a temperature at least 10 degrees Celsius greater than gaseous stream 30, such as at least 20 degrees Celsius, or at least 40 degrees Celsius.

Each heat transfer stage 44 of conditioning vessel 12 may be a bounded region within or extending through conditioning vessel 12 through which a heat transfer fluid (e.g., gaseous stream 30) travels on one side and solid feed material 24 travels on an opposite side. For example, each heat transfer stage may be formed by a group of tubes arranged parallel to each other (e.g., within a common horizontal plan) and in fluid communication with each other. Groups of tubes in different planes (e.g., different horizontal planes located at vertically spaced apart locations relative to each other) may form different heat transfer stages. Thermal energy can transfer via conduction through material surfaces separating the thermal transfer fluid from solid feed material 24. For example, thermal energy may transfer through a tube separating the thermal transfer fluid from solid feed material 24 in a shell and tube arrangement. As another example, thermal energy may transfer through a plate separating the thermal transfer fluid from solid feed material 24 in a plate and frame arrangement.

FIG. 3 is a top view illustration of an example heat transfer stage 44 that can be used in conditioning vessel 12. In the illustrated example, heat transfer stage 44 includes a plurality of tubes 56 disposed within and extending across shell 38. In operation, gaseous stream 30 can be introduced into tubes 56 through a respective inlet opening 46, causing the gaseous stream to flow sequentially from one tube to an adjacent tube before discharging through a corresponding outlet opening 48. As gaseous stream 30 flows through tubes 56, solid feed material 24 can flow through shell 38 and in contact with an external wall surface 58 of the tubes. This can facilitate heat transfer from gaseous stream 30 to solid feed material 24 through the wall surface of the plurality of tubes 56. Each group of tubes 56 within conditioning vessel 12 (e.g., fluidly connected with a common heat transfer fluid inlet opening and outlet opening) can form a respective one of the plurality of heat transfer stages 44.

Because gaseous stream 30 may have a tendency to causing fouling within the one or more heat transfer stages 44 through which it is passed, conditioning vessel may be configured with monitoring equipment around the one or more stages utilizing gaseous stream 30. In one example, conditioning vessel 12 is configured with temperature sensors to measure the temperature drop of gaseous stream 30 across the one or more heat transfer stages 44 through which it is passed. Additionally or alternatively, conditioning vessel 12 may be configured with pressure sensors to measure the pressure drop of gaseous stream 30 across the one or more heat transfer stages 44 through which it is passed. Changes in the temperature drop and/or pressure drop across the one or more heat transfer stages 44 through which gaseous stream 30 is passed during the course of operation may be an indication of accumulated fouling within the one or more heat transfer stages. Accumulated fouling can reduce heat transfer efficiency within the system.

To allow for periodic cleaning/inspection of the one or more heat transfer stages 44 through which gaseous stream 30 is passed, the heat transfer stages may be configured with an access port. The access port, when opened, can provide access to the plurality of tubes 54 into which gaseous stream 30 is introduced, e.g., to allow for cleaning of accumulated fouling in the plurality of tubes.

In addition, in some examples, one or more heat transfer stages 44 are configured with a bypass line configured to convey heat transfer fluid from a lower heat transfer stage to an upper heat transfer stage (or discharge port, where the heat transfer stage is an uppermost heat transfer stage), thereby causing the heat transfer fluid to bypass the stage having the bypass line. In normal operation, the bypass line can be closed such that heat transfer fluid flows through the heat transfer stage having the bypass line. If cleaning of the stage is desired, however, the bypass line can be opened to cause heat transfer fluid to flow through the bypass line instead of through the heat transfer stage. This allows the heat transfer stage to be isolated, e.g., for cleaning without entirely shutting down operation of conditioning vessel 12.

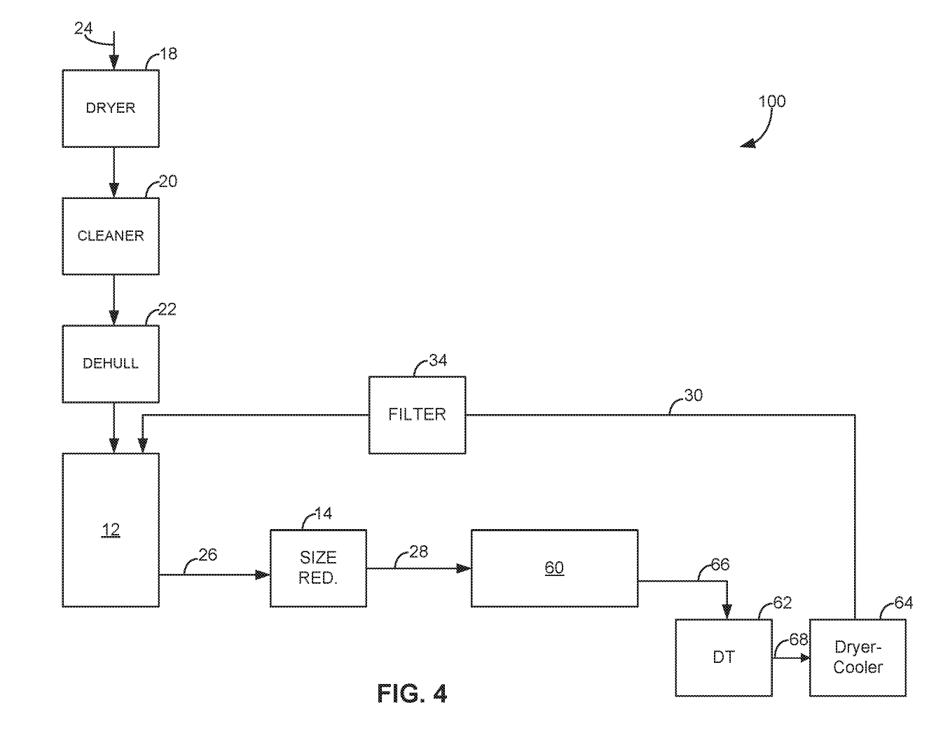

As noted above, a variety of different downstream processes and unit operations may generate energy-rich streams from which thermal energy is desirably recycled to an upstream processing unit. FIG. 4 is a block diagram of another example system that includes a heat recovery arrangement according to the disclosure. In the example of FIG. 4, like reference numerals refer to like components discussed above with respect to FIGS. 1-3. In some examples, the system of FIG. 4 is used to process soy materials, such as soy beans and/or protein concentrate. In contrast to the example of FIG. 1 in which a gaseous stream 30 is generated by cooking vessel 16 and recycled back to conditioning vessel 12, in the example arrangement of FIG. 4, gaseous stream 30 is generated by a dryer-cooler and recycled back to conditioning vessel 12.

In the example of FIG. 4, system 100 includes previously described conditioning vessel 12 and size reduction device 14, among other elements. System 100 also includes an extractor 60, a desolventizer-toaster 62, and a dryer-cooler 64. In operation, conditioned solid material 26 (or conditioned solid material of reduced size 28 in instances in which size reduction device 14 is used) is fed to extractor 60. Extractor 60 can contact the received material with a solvent (e.g., organic solvent) to generate a miscella stream containing solvent and components extracted from the feedstock being processed by the extractor.

For example, extractor 60 may be implemented using a batch extractor and/or a continuous extractor in which the extractor conveys a continuous flow of material from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet. In different examples, extractor 60 may be implemented as an immersion extractor, a percolation extractor, or yet other type of extractor design.

Solvent-wet solid material 66 on which extraction has been performed can be discharged by extractor 60 and received by desolventizer-toaster (“DT”) 62. DT 62 is typically a vertically oriented cylinder with multiple trays that are steam, hot water, and/or oil heated. For example, DT 62 can employ indirect heat transfer to desolventize ethanol, hexane or other solvent-wet products. DT 62 can generate a gaseous stream, which may or may not be recycled to conditioner 12 (not illustrated in FIG. 4) and a dried product stream 68. The dried product stream 68 can be fed to dryer-cooler 64. Dryer-cooler 64 can further dry and cool product stream 68, e.g., by injecting heated air in a drying section and using ambient-temperature air to cool the material in a cooling section. For example, an evenly distributed flow of hot air and cool air in a counter-current system can dry and cool the received product stream 68. Dryer-cooler 64 can generate a dried and cooled product stream along with a gaseous stream 30, which can be recycled back to conditioner 12 as discussed above with respect to FIGS. 1-3.

By recovering and utilizing thermal energy liberated during the processing of granular material, such as oleaginous seeds and beans, and directly reusing that thermal energy in upstream processes, the overall efficiency of the processing operation is improved. As a result, the capital costs for constructing the system can be reduced and the ongoing operating costs for running the system also reduced.

Various examples have been described. These and other examples are within the scope of the following claims.

1. A method comprising:
conveying a granular solid through a conditioning vessel having a shell and a plurality of tubes disposed within the shell, where conveying the granular solid through the conditioning vessel comprises conveying the granular solid through the shell so as to contact external wall surfaces of the plurality of tubes, thereby heating the granular solid and producing a conditioned granular solid;
discharging the conditioned granular solid from the conditioning vessel and introducing the conditioned granular solid into a size reduction device;
processing the conditioned granular solid within the size reduction device to reduce a size of the conditioned granular solid, thereby producing a conditioned granular solid of reduced size;
discharging the conditioned granular solid of reduced size from the size reduction device and introducing the conditioned granular solid of reduced size into a cooking vessel;
heating the conditioned granular solid of reduced size in the cooking vessel to a temperature greater than a temperature to which the granular solid was heated in the conditioning vessel, thereby generating a cooked solid and a gaseous stream comprising water vapor generated from the conditioned granular solid of reduced size; and
discharging the gaseous stream from the cooking vessel and introducing the gaseous stream into at least some of the plurality of tubes of the conditioning vessel, thereby transferring thermal energy carried by the gaseous stream flowing through the plurality of tubes through wall surfaces of the tubes and into the granular solid being conveyed through the shell.

2. The method of claim 1, wherein the conditioning vessel comprises an inlet opening through which granular solid is introduced into the conditioning vessel and a discharge opening through which conditioned granular solid is discharged from the conditioning vessel, and the inlet opening is vertically elevated relative to the discharge opening such that the granular solid is conveyed under a force of gravity from the inlet opening to the discharge opening.

3. The method of claim 1, wherein the plurality of tubes are arranged in groups, each group of tubes forms a heat transfer stage, and each heat transfer stage is positioned at a different vertically elevated position in the conditioning vessel relative to each other heat transfer stage.

4. The method of claim 3, wherein the plurality of tubes within each group of tubes are arranged parallel to one another.

5. The method of claim 3, wherein introducing the gaseous stream into at least some of the plurality of tubes of the conditioning vessel comprises introducing the gaseous stream into a group of tubes forming an uppermost heat transfer stage.

6. The method of claim 5, further comprising at least one of drawing the gaseous stream through the plurality of tubes via a fan positioned downstream of the conditioning vessel and pushing the gaseous stream through the plurality of tubes via a fan positioned upstream of the conditioning vessel.

7. The method of claim 5, further comprising drawing the gaseous stream through the plurality of tubes via a fan positioned downstream of the conditioning vessel.

8. The method of claim 5, further comprising:
introducing the gaseous stream into a group of tubes forming a second heat transfer stage positioned vertically below the uppermost heat transfer stage;
discharging the gaseous stream from the group of tubes forming the second heat transfer stage and delivering the gaseous stream from the second heat transfer stage to the uppermost heat transfer stage.

9. The method of claim 8, wherein delivering the gaseous stream from the second heat transfer stage to the uppermost heat transfer stage comprises bypassing at least one heat transfer stage positioned between the second heat transfer stage and the uppermost heat transfer stage.

10. The method of claim 9, further comprising heating the at least one heat transfer stage positioned between the second heat transfer stage and the uppermost heat transfer stage with a heat transfer fluid different than the gaseous stream.

11. The method of claim 3, wherein introducing the gaseous stream into at least some of the plurality of tubes of the conditioning vessel comprises introducing the gaseous stream into a first group of tubes forming one heat transfer stage, and further comprising introducing a heat transfer fluid different than the gaseous stream into a second group of tubes forming a second heat transfer stage.

12. The method of claim 1, wherein the gaseous stream further comprises air, entrained solids, and condensate, and further comprising, prior to introducing the gaseous stream into at least some of the plurality of tubes of the conditioning vessel, filtering the gaseous stream.

13-15. (canceled)

16. The method of claim 1, wherein
heating the granular solid within the conditioning vessel comprises heating the granular solid to a temperature ranging from 40 degrees Celsius to 70 degrees Celsius, and
heating the conditioned granular solid of reduced size in the cooking vessel to a temperature greater than a temperature to which the granular solid was heated in the conditioning vessel comprises heating the conditioned granular solid of reduced size in the cooking vessel to a temperature ranging from 70 degrees Celsius to 95 degrees Celsius.

17-19. (canceled)

20. The method of claim 1, wherein the granular solid is selected from the group consisting of soybeans and rapeseed.

21. The method of claim 20, further comprising discharging the cooked solids from the cooking vessel and introducing the cooked solids into a press, and pressing the cooking solids within the press so as to release liquid retained in the cooked solids.

22. A system comprising:
a conditioning vessel having a chamber with an inlet opening configured to receive granular solid and a discharge opening configured to discharge conditioned granular solid, the chamber being configured to receive at least one heat transfer fluid and pass the heat transfer fluid through at least a portion of the chamber, thereby heating granular solid within the chamber and producing the conditioned granular solid;
a size reduction device configured to receive the conditioned granular solid discharged from the discharge opening of the conditioning vessel and reduce a size of the conditioned granular solid so as to produce a conditioned granular size of reduced size;
a cooking vessel configured to receive the granular solid of reduced size from the size reduction device and heat the granular solid of reduced size to a temperature greater than a temperature to which the granular solid was heated in the conditioning vessel, thereby generating a cooked solid and a gaseous stream comprising water vapor generated from the conditioned granular solid of reduced size; and
a fluid conduit configured to transfer the gaseous stream from the cooking vessel to the conditioning vessel, thereby providing the gaseous stream as the heat transfer fluid passing through at least a portion of the chamber.

23. The system of claim 22, wherein the inlet opening is vertically elevated relative to the discharge opening such that the granular solid is configured to flow under a force of gravity from the inlet opening to the discharge opening.

24. The system of claim 22, wherein the conditioning vessel comprises a plurality of tubes disposed within the chamber and the conditioning vessel is configured to receive the at least one heat transfer fluid by passing the heat transfer fluid through at least some of the plurality of tubes.

25. (canceled)

26. The system of claim 24, wherein the plurality of tubes are arranged in groups and each group of tubes forms a heat transfer stage.

27. The system of claim 26, wherein at least one heat transfer stage comprises a bypass configured to convey heat transfer fluid from a lower heat transfer stage to an upper heat transfer stage through the bypass, thereby allowing the heat transfer stage comprising the bypass to be isolated for cleaning.

28. The system of claim 26, wherein the conditioning vessel is configured to receive the gaseous stream as the heat transfer fluid in a first heat transfer stage and a different heat transfer fluid in a second heat transfer stage.

29. The system of claim 28, further comprising a fan positioned at least one of downstream of the conditioning vessel and being configured to draw the gaseous stream through the first heat transfer stage and upstream of the conditioning vessel and being configured to push the gaseous stream through the first heat transfer stage.

30-31. (canceled)

32. The system of claim 26, wherein
the conditioning vessel is configured to discharge gaseous vapor with the conditioned granular solid through the discharge opening, and
further comprising an exhaust fluid conduit configured to transfer at least a portion of the gaseous vapor discharged through the discharge opening of the conditioning vessel to the plurality of tubes, thereby providing the gaseous vapor as a heat transfer fluid.

33. (canceled)

34. The system of claim 22, further comprising a filter positioned to filter the gaseous stream prior to passing the gaseous stream through at least a portion of the chamber.
